(19) United States
(12) Patent Application Publication
(10) Pub. No.: US 2015/0357853 A1
(43) Pub. Date: Dec. 10, 2015

(54) MOTOR-DRIVEN APPLIANCE AND MAIN BODY THEREOF

(71) Applicant: MAKITA CORPORATION, Anjo-shi, Aichi (JP)

(72) Inventors: Hitoshi SUZUKI, Anjo-shi (JP); Masafumi NODA, Anjo-shi (JP); Tomoo MURAMATSU, Anjo-shi (JP); Toru YAMADA, Anjo-shi (JP); Takuya KUSAKAWA, Anjo-shi (JP)

(73) Assignee: MAKITA CORPORATION, Anjo-shi, Aichi (JP)

(21) Appl. No.: 14/763,574

(22) PCT Filed: Dec. 25, 2013
(86) PCT No.: PCT/JP2013/084720

§ 371 Date: Jul. 27, 2015

(30) Foreign Application Priority Data
Feb. 1, 2013 (JP) 2013-018652

(51) Int. Cl. H02J 7/00; H02P 29/00

(52) U.S. Cl. CPC H02J 7/0063; H02P 29/00; H02J 2007/0067

(57) ABSTRACT

A main body of a motor-driven appliance is configured such that a plurality of battery packs are attachable thereto. Each of the battery packs contains a battery. The main body of the motor-driven appliance acquires, from each of the plurality of battery packs, discharge capacity information indicating a discharge capacity of the contained battery. The main body of the motor-driven appliance sets at least one control parameter to control discharge from a power source to a motor, in accordance with at least the discharge capacity information of a battery with a lowest discharge capacity, among the acquired respective discharge capacity information.

### CROSS-REFERENCE TO RELATED APPLICATIONS

This international application claims the benefit of Japanese Patent Application No. 2013-018652 filed Feb. 1, 2013 in the Japan Patent Office, and the entire disclosure of Japanese Patent Application No. 2013-018652 is incorporated herein by reference.

### TECHNICAL FIELD

The present invention relates to a motor-driven appliance.

### BACKGROUND ART

An electric power tool disclosed in Patent Document 1 below is configured such that two battery packs can be attached to a main body of the electric power tool. In the electric power tool, a voltage required to properly drive the electric power tool is obtained by serially connecting the two battery packs that are attached to the main body of the electric power tool.

### PRIOR ART DOCUMENTS

### Patent Documents

Patent Document 1: Japanese Unexamined Patent Application Publication No. 2011-161602

### SUMMARY OF THE INVENTION

### Problems to be Solved by the Invention

In the case of an electric power tool in which a plurality of battery packs are serially connected for use, various battery packs having different discharge capacities might be used in a combined manner. For example, a new battery pack and an old battery pack might be present in a mixed manner, or a plurality of battery packs, each having different initial characteristics, might be present in a mixed manner.

When a plurality of battery packs having different discharge capacities are serially connected and used, damage might be caused particularly to a battery pack having a lower discharge capacity, depending on a difference in discharge capacity. For example, when a battery pack having a high internal impedance (i.e., having a low discharge capacity) and a battery pack having a low internal impedance (i.e., having a high discharge capacity) are serially connected and used, a battery voltage of the battery having the high internal impedance is reduced relatively largely, whereas a battery voltage of the battery having the low internal impedance is not largely reduced.

As a result, a total voltage to be applied to a load is not largely reduced, and it is possible to flow to the load a large current corresponding to the applied voltage. Then, the battery having the high internal impedance is likely to suffer damage due to a larger reduction of the battery voltage. Also, as the current becomes larger, heat generation inside the battery becomes larger in the battery having the high internal impedance, which may result in large damage.

In one aspect of the present invention, it is desirable, in a motor-driven appliance that operates receiving power supply from a plurality of battery packs connected in series, to inhibit damage to the battery packs (particularly to battery packs having lower discharge capacities) due to discharge even in a case where the plurality of battery packs have different discharge capacities and to thereby achieve appropriate discharge control.

### Means for Solving the Problems

A motor-driven appliance in one aspect of the present invention comprises: a plurality of battery packs, an attachment unit, a power source forming unit, a motor, an information acquisition unit, a control parameter setting unit, and a control unit.

Each of the plurality of battery packs comprises a battery contained therein. The plurality of battery packs are detachably attached to the attachment unit. The power source forming unit forms a power source by serially connecting the respective batteries of the plurality of battery packs when the plurality of battery packs are attached to the attachment unit. The motor operates by electric power supplied from the power source that is formed by the power source forming unit.

The information acquisition unit acquires, from each of the plurality of battery packs, discharge capacity information that is information indicating the discharge capacity of the battery contained in each of the plurality of battery packs. The control parameter setting unit sets at least one control parameter to control discharge from the power source to the motor in accordance with at least the discharge capacity information of a battery having a lowest discharge capacity, on the basis of the respective discharge capacity information acquired by the information acquisition unit. The control unit controls the discharge from the power source to the motor by using the at least one control parameter set by the control parameter setting unit.

According to the motor-driven appliance configured as above, the control parameter is set in accordance with the discharge capacity of the battery having the lowest discharge capacity in the plurality of battery packs attached, and the discharge to the motor is controlled on the basis of the control parameter. As a result, it is possible to set an appropriate control parameter in view of the battery having the lowest discharge capacity. Accordingly, even when the plurality of batteries have different discharge capacities, it is possible to inhibit damage to the batteries (particularly to batteries having lower discharge capacities) and to thereby perform appropriate discharge control.

The control parameter for discharge control may be, for example, a parameter indicating a limitation range to limit or stop discharge with respect to a physical quantity indicating a state of discharge from the power source. In this case, the control unit may be configured to limit or stop discharge from the power source to the motor when the aforementioned physical quantity enters the limitation range indicated by the corresponding control parameter.

By setting the limitation range to limit or stop discharge on the basis of the discharge capacity of the battery having the lowest discharge capacity, it is possible to effectively inhibit damage to the battery having the lowest discharge capacity during the discharge.

In this case, more specifically, at least one of an overcurrent threshold, an overdischarge threshold, and an overload threshold may be set as the control parameter. The overcurrent threshold is an upper limit of a discharge current during the discharge from the power source to the motor. The overdischarge threshold is a lower limit of a voltage of the power source during the discharge. The overload threshold is an upper limit of an integrated value of the discharge current from the power source while the discharge to the motor is continuously performed.

By setting at least one of the overcurrent threshold, the overdischarge threshold, and the overload threshold as the control parameter (moreover, setting on the basis of the discharge capacity of the battery having the lowest discharge capacity), it is possible to effectively protect each of the batteries from overcurrent, overdischarge, or overload, and thus to more effectively inhibit damage to the discharge battery having the lowest discharge capacity.

The discharge capacity information to be acquired from the battery pack may be various. In a case where the discharge capacity information includes at least information indicating a degree of degradation of each battery, the control parameter setting unit may set at least one control parameter on the basis of the degree of degradation of a battery with a highest degree of degradation.

When a battery degrades due to repeated use of the battery or other causes, for example, an internal impedance of the battery is increased; thus, the discharge capacity of the battery is lowered. Accordingly, by acquiring information indicating a degree of degradation of a battery from each battery, setting a control parameter on the basis of the acquired information, and controlling the discharge, it is possible to effectively inhibit damage to the batteries (particularly to a battery with a highest degree of degradation) due to the discharge and to thereby perform appropriate discharge control.

When the discharge capacity information to be acquired from the battery pack includes information indicating initial characteristics of the battery cells forming the battery, the control parameter setting unit may set at least one control parameter on the basis of the initial characteristics of a battery with a lowest discharge capacity indicated by the initial characteristics.

If the battery cells have different initial characteristics, the corresponding batteries have different discharge capacities. Accordingly, by acquiring information indicating respective initial characteristics of the battery cells from each battery, setting a control parameter on the basis of the acquired information, and controlling the discharge, it is possible to effectively inhibit damage to the batteries (particularly to a battery with a lowest discharge capacity indicated by the initial characteristics) due to the discharge, to thereby perform appropriate discharge control.

In the case of performing discharge control by setting an overcurrent threshold or an overload threshold on the basis of a battery with a lowest discharge capacity, when a discharge amount to the motor has reached the set threshold, a notification may be given to enable recognition of the battery with the lowest discharge capacity.

Specifically, the control parameter setting unit sets, as the control parameter, at least one of an overcurrent threshold and an overload threshold. The overcurrent threshold is an upper limit of the discharge current during the discharge from the power source to the motor. The overload threshold is an upper limit of an integrated value of the discharge current from the power source while the discharge to the motor is continuously performed. When, among physical quantities indicating the state of discharge from the power source, a physical quantity corresponding to the overcurrent threshold or the overload threshold (that is, the discharge current or the integrated value of the discharge current) has reached the corresponding threshold, a notification unit gives a specified notification indicating the battery with the lowest discharge capacity.

By giving a notification of the battery with the lowest discharge capacity when the discharge amount has reached the threshold, a user of the motor-driven appliance can recognize which battery is in a state with the lowest discharge capacity. Accordingly, the user can take appropriate measures, such as replacing the battery specified by the notification with a battery having a high discharge capacity, at an appropriate time in accordance with the notified information; thus, improved work efficiency and usability for the user can be achieved.

A main body of a motor-driven appliance in the second aspect of the present invention comprises an attachment unit, a power source forming unit, a motor, an information acquisition unit, a control parameter setting unit, and a control unit.

A plurality of battery packs are detachably attached to the attachment unit. The power source forming unit forms a power source by serially connecting the respective batteries of the plurality of battery packs when the plurality of battery packs are attached to the attachment unit. The motor operates by electric power supplied from the power source formed by the power source forming unit. The information acquisition unit acquires, from each of the plurality of battery packs, discharge capacity information that is information indicating the discharge capacity of the battery contained in the battery pack. The control parameter setting unit sets at least one control parameter to control discharge from the power source to the motor in accordance with at least the discharge capacity information of the battery with the lowest discharge capacity, on the basis of the respective discharge capacity information acquired by the information acquisition unit. The control unit controls the discharge from the power source to the motor by using the at least one control parameter set by the control parameter setting unit.

According to the main body configured as above, an appropriate control parameter is set in accordance with the discharge capacity of the battery with the lowest discharge capacity in the attached plurality of battery packs, and discharge to the motor is controlled on the basis of the control parameter. Thus, the same effects as in the first aspect of the present invention can be achieved.

### BRIEF DESCRIPTION OF THE DRAWINGS

FIG. 1 is a perspective view of a motor-driven appliance according to an embodiment to which the present invention is applied.

FIG. 2 is a circuit diagram showing an electrical configuration of the motor-driven appliance of the embodiment.

FIG. 3 is a flowchart of a main process executed by an MCU of a control circuit.

FIG. 4A is a flowchart showing a discharge control process in S210 of the main process in FIG. 3.

FIG. 4B is a flowchart showing the discharge control process in S210 of the main process in FIG. 3.

FIG. 5 is a perspective view showing an example of a electric power tool to which the present invention is applicable.

### EXPLANATION OF REFERENCE NUMERALS

1, 100 . . . motor-driven appliance; 2 . . . motor unit; 3 . . . shaft pipe; 4 . . . cutter; 5 . . . cutter attachment unit; 6 . . . handle; 7 . . . right-hand grip; 8 . . . left-hand grip; 9 . . . trigger switch; 10, 103 . . . main body; 11, 101 . . . first battery pack 12, 102 . . . second battery pack; 13, 104 . . . battery attachment unit; 15 . . . control circuit; 16 . . . first indicator; 17 . . . second indicator; 20, 40 . . . battery; 21-25, 41-45 . . . cell; 27, 47 . . . first transistor; 28, 48 . . . second transistor; 31, 51 . . . positive terminal; 32, 52 . . . negative terminal; 33, 53 . . . signal output terminal; 34, 54 . . . data communication terminal; 61 . . . motor; 62 . . . MCU; 63 . . . power circuit; 64 . . . operation detection circuit; 65 . . . drive FET; 66 . . . driver; 67 . . . current detection circuit; 68 . . . differential amplifier; 69 . . . voltage divider; 70 . . . main switch; 71 . . . potentiometer; 72, 73, 74 . . . diode; 81 . . . first positive terminal 82 . . . first negative terminal; 83, 93 . . . signal input terminal; 84 . . . first data communication terminal; 91 . . . second positive terminal; 92 . . . second negative terminal; 94 . . . second data communication terminal.

### MODE FOR CARRYING OUT THE INVENTION

Hereinafter, a preferred embodiment of the present invention will be described with reference to the drawings. The present invention is not limited to specific means, structures, etc. shown in the embodiment below, and may be practiced in various forms within the scope not departing from the subject matter of the present invention. Also, a mode in which some part of the configuration of the embodiment below is omitted as long as the problems to be solved can be solved is included in the embodiment of the present invention.

(1) Overall Configuration of Motor-Driven Appliance

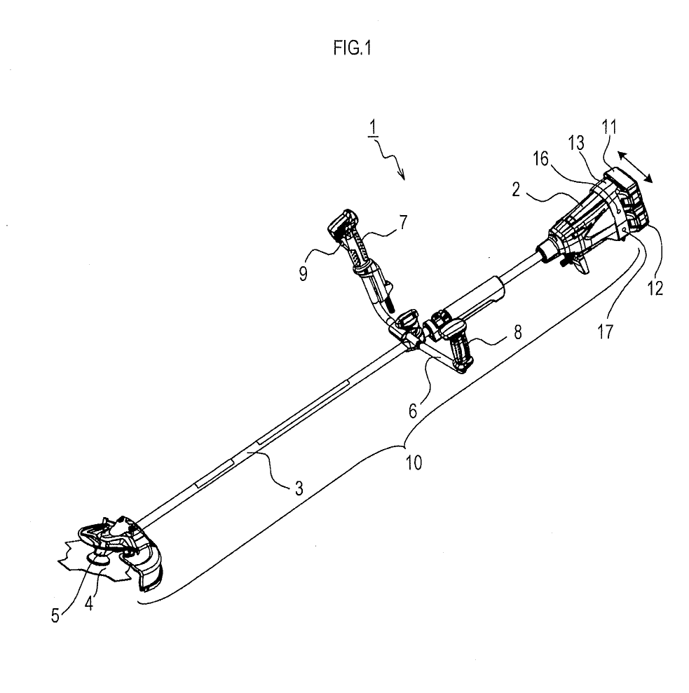

As shown in FIG. 1, a motor-driven appliance 1 of the present embodiment is configured as an electric working machine, more specifically as a so-called brush cutter to cut grass, small-diameter woods, and the like.

A main body 10 of the motor-driven appliance 1 comprises a motor unit 2 and a shaft pipe 3. The shaft pipe 3 is coupled to one end of the motor unit 2.

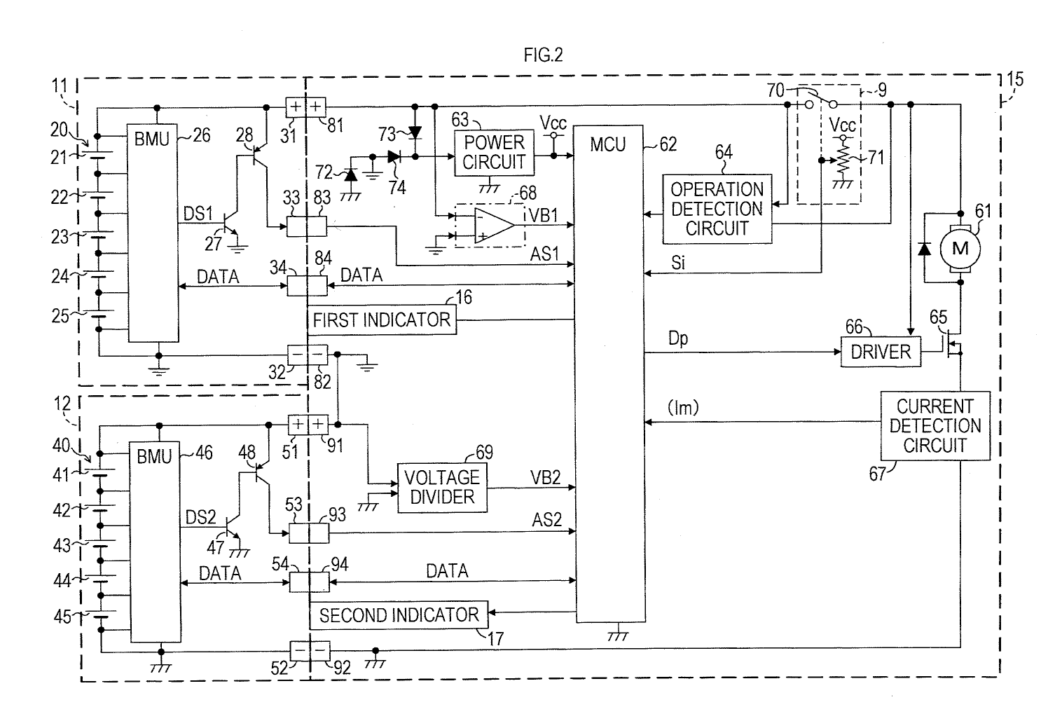

Inside the motor unit 2, there are housed a later-described motor 61 (see FIG. 2) and a control circuit 15 to control the motor 61. The motor 61 of the present embodiment is a brushed direct current motor.

At the other end of the motor unit 2, there is provided a battery attachment unit 13 for detachable attachment of two battery packs, i.e., a first battery pack 11 and a second battery pack 12. More specifically, the battery attachment unit 13 is configured such that each of the battery packs 11, 12 is individually attachable to and detachable from the battery attachment unit 13 by being slid, on the battery attachment unit 13, in corresponding directions indicated by an arrow in the figure.

A first indicator 16 indicating a state or the like of the first battery pack 11 and a second indicator 17 indicating a state or the like of the second battery pack 12 are provided to one side surface of an outer cover of the motor unit 2. Each of the first and second indicators 16 and 17, more specifically, comprises an LED, which is a light emitting element, and a drive circuit to drive the LED. In place of the first and second indicators 16 and 17, indicators in different forms may be employed.

The shaft pipe 3 has a hollow shaft shape. At an end of the shaft pipe 3 opposite to the motor unit 2, there is provided a cutter attachment unit 5 for detachable attachment of a cutter 4. The cutter 4 as a whole is generally disk shaped and has a periphery provided with a plurality of blades.

In the vicinity of an axial middle position of the shaft pipe 3, a handle 6 is provided. The handle 6 comprises a right-hand grip 7 to be held by the right hand of a user of the motor-driven appliance 1 and a left-hand grip 8 to be held by the left hand of the user. A trigger switch 9 for the user to operate rotation of the cutter 4 is provided to the right-hand grip 7.

The shaft pipe 3 houses therein a not-shown driving force transmission shaft (hereinafter simply referred to as the “transmission shaft”). One end of the transmission shaft is coupled to a rotor of the later-described motor 61 that is housed in the motor unit 2. The other end of the transmission shaft is coupled to the cutter 4 through a not-shown plurality of gears provided to the cutter attachment unit 5. Accordingly, a rotational driving force of the motor 61 is transmitted to the cutter 4 through the transmission shaft and the plurality of gears.

(2) Electrical Configuration of Motor-Driven Appliance

The motor-driven appliance 1 has a circuit configuration as shown in FIG. 2. FIG. 2 shows respective internal circuits of the battery packs 11 and 12, and the control circuit 15 in the main body. For convenience of description, FIG. 2 also shows the trigger switch 9 and the motor 61 in the control circuit 15.

The first battery pack 11 comprises a battery 20. The battery 20 comprises a plurality of (five in the present embodiment) serially connected cells 21, 22, 23, 24, and 25. The second battery pack 12 comprises a battery 40. The battery 40 comprises a plurality of (five in the present embodiment) serially connected cells 41, 42, 43, 44, and 45. Each of the cells 21 to 25 and 41 to 45 in the present embodiment is configured as a secondary battery (for example, a lithium ion secondary battery) cell. Hereinafter, the voltage of each of the cells 21 to 25 and 41 to 45 is simply referred to as the “cell voltage”. Also, a “battery voltage” with respect to the battery 20 means the voltage of the battery 20. Further, a “battery voltage” with respect to the first battery pack 11 means the voltage of the battery 20 provided in the first battery pack 11. The same is applicable to the second battery pack 12 and the battery 40 provided therein.

In the first battery pack 11, a positive electrode of the battery 20 is connected to a positive terminal 31, and a negative electrode of the battery 20 is connected to a negative terminal 32. When the first battery pack 11 is attached to the main body 10, the positive terminal 31 and the negative terminal 32 are connected respectively to a first positive terminal 81 and a first negative terminal 82 of the main body 10.

In the second battery pack 12, a positive electrode of the battery 40 is connected to a positive terminal 51, and a negative electrode of the battery 40 is connected to a negative terminal 52. When the second battery pack 12 is attached to the main body 10, the positive terminal 51 and the negative terminal 52 are connected respectively to a second positive terminal 91 and a second negative terminal 92 of the main body 10.

The first battery pack 11 comprises a battery management unit (BMU) 26 to monitor the state of the battery 20 and to perform various processes. The BMU 26 monitors the state of the battery 20, such as the voltage of the battery 20 (the battery voltage), the voltages (the cell voltages) of the cells 21 to 25, and the like. The BMU 26 can perform data communication with a control unit (MCU) 62 of the main body 10 through a data communication terminal 34, and transmits information about the battery 20 to the MCU 62 when needed.

The information that the BMU 26 transmits to the MCU 62 includes at least an internal resistance (internal impedance) value DCIR1, an overcurrent threshold LC1, and an overload threshold OL1 of the battery 20. Such information indicates a discharge capacity of the battery 20. More specifically, the internal resistance value DCIR1 is information that indicates a degree of degradation of the battery 20, and the thresholds LC1 and OL1 are information that indicates initial characteristics of the battery cells 21 to 25 forming the battery 20.

As the degradation of the battery 20 progresses further, the internal resistance value DCIR1 becomes larger. Accordingly, it may be considered that the discharge capacity of the battery 20 is lower, as the internal resistance value DCIR is larger. The BMU 26 in the first battery pack 11 periodically calculates the internal resistance value DCIR1 on the basis of the voltage, current value, and the like of the battery 20, and stores a calculated value in a not-shown memory. Thus, it can be said that the BMU 26 constantly calculates and stores the latest internal resistance value DCIR1.

The overcurrent threshold LC1 and the overload threshold OL1 are stored, as one of the initial characteristics of the battery cells 21 to 25 forming the battery 20, in a not-shown memory in the BMU 26 before shipping of the first battery pack 11. These thresholds LC1 and OL1, which are sometimes used, for example, for protection of the battery 20 in the first battery pack 11, are transmitted to the MCU 62 in the main body 10 and used in the MCU 62 in the present embodiment.

The overcurrent threshold LC1 is a value that indicates an upper limit of a discharge current from the battery 20; the overload threshold OL1 is a value that indicates an upper limit of a time-integrated (integral) value of a discharge current during a continuous discharge while discharge from the battery 20 is being continued. Accordingly, it can be said that the discharge capacity of the battery 20 is lower, as the value of threshold LC1 or OL1 is smaller. When required by the MCU 62 of the main body, the BMU 26 transmits the internal resistance value DCIR, the overcurrent threshold LC1 and the overload threshold OL1 to the MCU 62.

The BMU 26 outputs a discharge stop signal DS1 indicating that discharge from the battery 20 should be prohibited when such prohibition is required. An output terminal for the discharge stop signal DS1 in the BMU 26 is connected to a base of a first transistor 27. An emitter of the first transistor 27 is connected to a first ground line (a ground line having the same electrical potential as the negative electrode of the battery 20 of the first battery pack 11), and a collector thereof is connected to a base of a second transistor 28. An emitter of the second transistor 28 is connected to the positive electrode of the battery 20, and a collector thereof is connected to a signal output terminal 33.

The BMU 26 provides an output to the base of the first transistor 27 at a High level (H-level) when discharge should be permitted; the BMU 26 outputs a discharge stop signal DS1 at a Low level (L-level) to the base of the first transistor 27 when discharge should be stopped.

With the above configuration, while discharge from the battery 20 should be permitted and a discharge stop signal DS1 is not outputted from the BMU 26 (i.e., during an output at the H-level), the transistors 27 and 28 are turned on, and a battery voltage is outputted from the signal output terminal 33. The battery voltage outputted from the signal output terminal 33 is inputted through a signal input terminal 83 to the MCU 62 in the main body 10. Although not shown in FIG. 2, an interface circuit is actually provided between the signal input terminal 83 and the MCU 62. The interface circuit is a circuit to shift the level of the battery voltage inputted from the first battery pack 11 to a specified low level and to input the low level voltage to the MCU 62.

When discharge from the battery 20 should be stopped and a discharge stop signal DS1 is outputted from the BMU 26 (i.e., an output at the L-level), the transistors 27 and 28 are turned off, and the level of an output from the signal output terminal 33 becomes “High-impedance” (“Hi-Z”). The output signal of the Hi-Z level is inputted to the MCU 62 in the main body 10 as a first stop signal AS1.

The second battery pack 12, which has the similar configuration to that of the first battery pack 11, comprises a BMU 46, two transistors 47 and 48, a signal output terminal 53, a data communication terminal 54, etc. The BMU 46 monitors the state of the battery 40, and executes a variety of processes. The two transistors 47 and 48, and the signal output terminal 53 are provided to transmit permission or stop of discharge from the battery 40 to the MCU 62 in the main body 10. The data communication terminal 54 is a terminal to perform data communication between the BMU 46 and the MCU 62 in the main body 10.

Since the second battery pack 12 has the same configuration and function as the first battery pack 11, detailed description of the second battery pack 12 is not given here. A brief description will be given of information that the BMU 46 transmits through the data communication terminal 54 to the MCU 62 in the main body. In a similar manner to the BMU 26 in the first battery pack 1, the BMU 46 in the second battery pack 12 transmits an internal resistance value DCIR2 of the battery 40, an overcurrent threshold LC2, and an overload threshold OL2 to the MCU 62 in the main body. These values DCIR2, LC2, and OL2 are information indicating the discharge capacity of the battery 40 of the second battery pack 12.

Next, a description will be given of the control circuit 15 in the main body 10. The control circuit 15 comprises the MCU 62, a power circuit 63, an operation detection circuit 64, a drive FET 65, a driver 66, a current detection circuit 67, a differential amplifier 68, a voltage divider 69, and two indicators 16 and 17.

In the control circuit 15, a current conduction path is formed from the first positive terminal 81 through the motor 61 to the second negative terminal 92. A path between the first positive terminal 81 and one end of the motor 61 in the current conduction path is provided with a trigger switch 9 to connect and disconnect the path. A path from the other end of the motor 61 to the second negative terminal 92 is provided with the drive FET 65 and the current detection circuit 67 that are serially connected in this order.

The trigger switch 9 more specifically comprises a main switch 70 and a potentiometer (variable resistor) 71. The main switch 70 is a switch to electrically connect and disconnect the path between the first positive terminal 81 and the one end of the motor 61. The potentiometer 71 is a member to generate an operation amount signal Si, which is an analog voltage according to an amount of pulling operation of the trigger switch 9 by a user.

When a user pulls the trigger switch 9 slightly, the main switch 70 is turned on, and the path between the first positive terminal 81 and the one end of the motor 61 becomes electrically connected. Then, if the user further pulls the trigger switch 9, an operation amount signal Si according to the amount of pulling operation is inputted to the MCU 62. Turning on (off) of the trigger switch 9 means turning on (off) of the main switch 70.

The first negative terminal 82 that is to be connected to the negative terminal 32 of the first battery pack 11 is connected to the second positive terminal 91 that is to be connected to the positive terminal 51 of the second battery pack 12. That is, when the battery packs 11 and 12 are attached to the main body 10, the batteries 20 and 40 become serially connected. As a result, a voltage between the first positive terminal 81 and the second negative terminal 92 of the main body 10, i.e., a driving voltage supplied to drive the motor 61, is equal to the sum of the battery voltages.

The power circuit 63 comprising a step-down regulator converts the battery voltage of the first battery pack 11 inputted through the first positive terminal 81 to a control voltage Vcc having a specified voltage value, and outputs the control voltage Vcc. The battery voltage of the first battery pack 11 is inputted from the first positive terminal 81 to an input terminal of the power circuit 63 through a diode 73. The control voltage Vcc outputted from the power circuit 63 is used as a power source for operation of the components in the control circuit 15, such as the MCU 62, the differential amplifier 68, the potentiometer 71 in the trigger switch 9, and the indicators 16 and 17.

A cathode of the diode 73 and also a cathode of another diode 74A are connected to the input terminal of the power circuit 63. An anode of the diode 74 is connected to the first ground line and also is connected to a cathode of a diode 72. An anode of the diode 72 is connected to a second ground line (having the same electrical potential as the negative electrode of the battery 40 of the second battery pack 12).

With the above configuration, when at least the first battery pack 11 is attached to the main body 10, the voltage of the battery 20 of the first battery pack 11 is supplied to the power circuit 63 to activate the power circuit 63, and thereby the control voltage Vcc is generated. Accordingly, when at least the first battery pack 11 of the two battery packs 11 and 12 is attached to the main body 10, the components, including the MCU 62, for which the control voltage Vcc serves as the power source, become operable.

The operation detection circuit 64 detects an on or off state of the trigger switch 9, and outputs a signal indicating the on or off state to the MCU 62. The current detection circuit 67 detects a current flowing into the motor 61 (hereinafter referred to as a “drive current Im”), and outputs a detection signal indicating the drive current Im to the MCU 62.

The differential amplifier 68 detects a battery voltage of the battery 20 of the first battery pack 11, and outputs a first voltage detection signal V131 according to the battery voltage to the MCU 62. The voltage divider 69 divides the battery voltage of the battery 40 of the second battery pack 12 by a specified voltage division ratio, and outputs the divided voltage value to MCU 62 as a second voltage detection signal VB2 indicating the battery voltage.

The MCU 62 is a control unit to control driving of the motor 61 by controlling the discharge from the power source formed by the serially connected batteries 20 and 40 to the motor 61. The MCU 62 comprises a microcomputer in the present embodiment. While the trigger switch 9 is off, the MCU 62 keeps the drive FET 65 off to thereby stop current conduction to the motor 61. When the trigger switch 9 is turned on, the MCU 62 performs PWM driving of the drive FET 65 to supply power from the batteries 20 and 40 to the motor 61, to thereby rotationally drive the motor 61.

Control of the drive FET 65 is performed specifically through the driver 66. To drive the motor 61 when the trigger switch 9 is turned on, the MCU 62 outputs to the driver 66 a PWM drive signal Dp having a duty ratio according to the amount of pulling operation of the trigger switch 9. The driver 66 provides (discharge) a current according to the amount of pulling operation on the basis of a PWM drive signal Dp inputted from the MCU 62 to the motor 61, to thereby drive (rotate) the motor 61.

To stop the motor 61 when the trigger switch 9 is turned off, the MCU 62 outputs a PWM drive signal Dp having a duty ratio of “0” to the driver 66 to completely turn off the drive FET 65, to thereby stop discharge to the motor 61. The driver 66 performs PWM driving of the drive FET 65 on the basis of the duty ratio of the PWM drive signal Dp inputted from the MCU.

When the first stop signal AS1 is inputted from the first battery pack 11, or a second stop signal AS2 is inputted from the second battery pack 12, the MCU 62 turns off the drive FET 65, to thereby stop the discharge from the battery packs 11 and 12 to the motor 61. The MCU 62 also controls operation of the indicators 16 and 17. Here, “operation” of the indicators 16 and 17 means lighting of LEDs in the present embodiment.

The MCU 62 is capable of data communication with the BMU 26 of the first battery pack 11 through a first data communication terminal 84, and is capable of data communication with the BMU 46 of the second battery pack 12 through a second data communication terminal 94.

Specifically, the MCU 62 acquires, when necessary, the internal resistance value DCIR1, the overcurrent threshold LC1, and the overload threshold OL1 of the battery 20 from the first battery pack 11 through the first data communication terminal 84. The MCU 62 also acquires, when necessary, the internal resistance value DCIR2, the overcurrent threshold LC2, and the overload threshold OL2 of the battery 40 from the second battery pack 12 through the second data communication terminal 94.

After acquiring the respective internal resistance values DCIR1 and DCIR2 from the battery packs 11 and 12, the MCU 62 calculates a limited current LCt on the basis of the internal resistance values DCIR1 and DCIR2. The limited current LCt, which is a value to be used in a later-described main process, is smaller than any of the overcurrent thresholds LC1 and LC2.

The MCU 62 limits or stops the discharge from the battery packs 11 and 12 to the motor 61 in the later-described main process on the basis of the calculated limited current LCt, and the thresholds LC1, LC2, OL1, OL2 acquired from the battery packs 11 and 12. Specifically, if the drive current Im becomes equal to or greater than the limited current LCt, the duty ratio of the PWM drive signal is controlled such that the drive current Im becomes less than the limited current LCt. Also, if the drive current Im becomes equal to or greater than any of the overcurrent thresholds, the discharge to the motor 61 is stopped. Further, if a load counter value OLc (a time-integrated value of the discharge current) calculated on the basis of the drive current Im becomes equal to or greater than any of the overload thresholds, the discharge to the motor 61 is stopped.

In brief, the MCU 62 of the present embodiment has a function to control the driving of the motor 61 as well as a discharge state monitoring function to monitor a state of the discharge to the motor 61 and to limit or stop, when needed, the discharge to the motor 61. However, it is not necessarily required for the single MCU 62 (more specifically, a single microcomputer) to have both of the two functions; the two functions may be achieved by individual MCUs, ICs, etc.

The MCU 62 comprises a not-shown memory, and stores in the memory the aforementioned various information acquired from the battery packs 11 and 12, a later-described motor stop flag, the load counter value OLc, etc.

(3) Description of Main Process Executed by MCU of Main Body

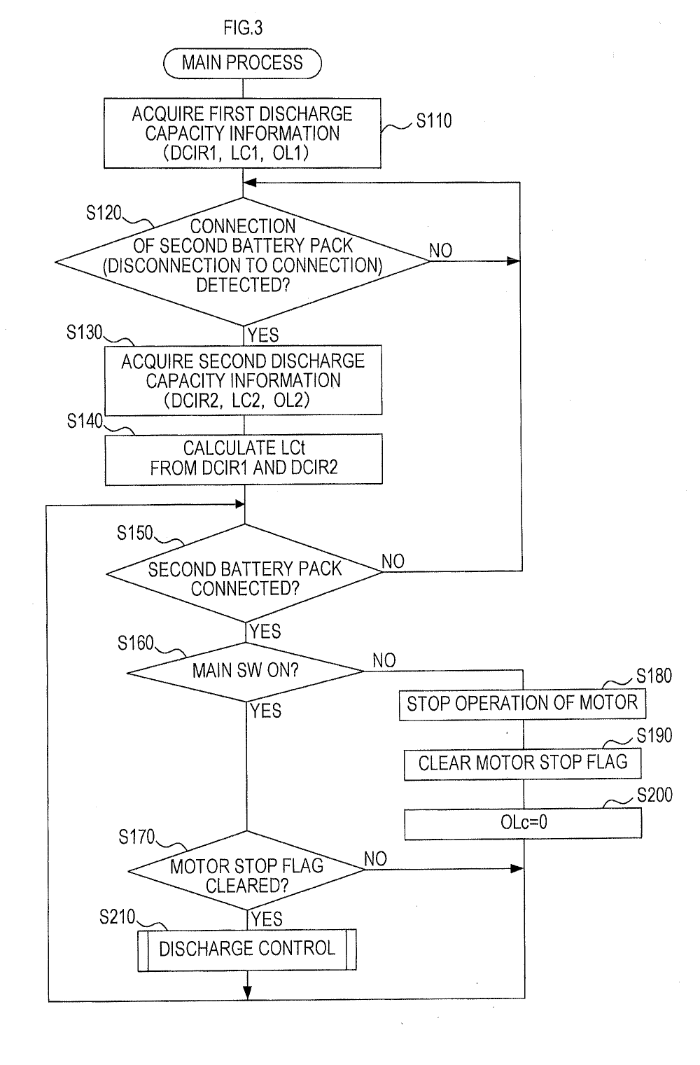

Next, a description will be given of a main process executed by the MCU 62 of the main body 10 with reference to FIG. 3. When at least the first battery pack 11 is attached and thereby the control voltage Vcc is supplied, the MCU 62 starts operation and executes the main process in FIG. 3.

When starting the main process in FIG. 3, the MCU 62 requests the BMU 26 of the first battery pack 11 for first discharge capacity information and acquires the first discharge capacity information in S110. Specifically, the MCU 62 acquires the internal resistance value DCIR1, the overcurrent threshold LC1, and the overload threshold OL1 of the battery 20.

In S120, it is determined whether connection of the second battery pack 12 is detected, that is, the second battery pack 12 is changed from a disconnected state to a connected state. Such determination may be made, for example, on the basis of the second voltage detection signal VB2 from the voltage divider 69. While connection of the second battery pack 12 is not detected, the determination in S120 is repeatedly made; once connection of the second battery pack 12 is detected, the process proceeds to S130.

In S130, second discharge capacity information is requested to the BMU 46 of the second battery pack 12, and thereby the second discharge capacity information is acquired. Specifically, the internal resistance value DCIR2, the overcurrent threshold LC2, and the overload threshold OL2 of the battery 40 are acquired.

In S140, the limited current LCt is calculated on the basis of the acquired internal resistance values DCIR1 and DCIR2. There may be various methods for calculating the limited current LCt. For example, it may be possible to calculate a current of a level at which an instantaneous overdischarge (for example, an overdischarge that causes power failure of the BMU in the battery pack, and thereby stops the operation of the BMU) is not caused, on the basis of the larger one of the internal resistance values DCIR, and to use the calculated current as the limited current LCt. Alternatively, for example, it may be possible to calculate a current of a level at which an instantaneous overdischarge (for example, an overdischarge that causes power failure of the MCU 62 of the main body 10 and thereby stops the operation of the MCU 62) is not caused, on the basis of a value obtained by adding the two internal resistance values DCIR1 and DCIR2, and to use the calculated current as the limited current LCt. As long as at least the larger one of the internal resistance values DCIR is used, there is no limitation to the calculation method of the limited current LCt,

After the calculation of the limited current LCt, it is determined in S150 whether the second battery pack 12 is connected. If the second battery pack 12 is not connected, the process returns to S120. If the second battery pack 12 is connected, the process proceeds to S160.

In S160, it is determined whether the main switch 70 is ON. If the main switch 70 is not ON, operation of the motor 61 is stopped in S180. That is, output of the PWM drive signal Dp is stopped (i.e., the duty ratio is set to “0”). Then, the motor stop flag is cleared in S190, the counter value OLc of the load counter is cleared to “0” in S200, and the process returns to S150.

If it is determined in S160 that the main switch 70 is ON, it is determined in S170 whether the motor stop flag is cleared. If the motor stop flag is not cleared, the process returns to S150. If the motor stop flag is cleared, a discharge control process in S210 is executed, and then the process returns to S150.

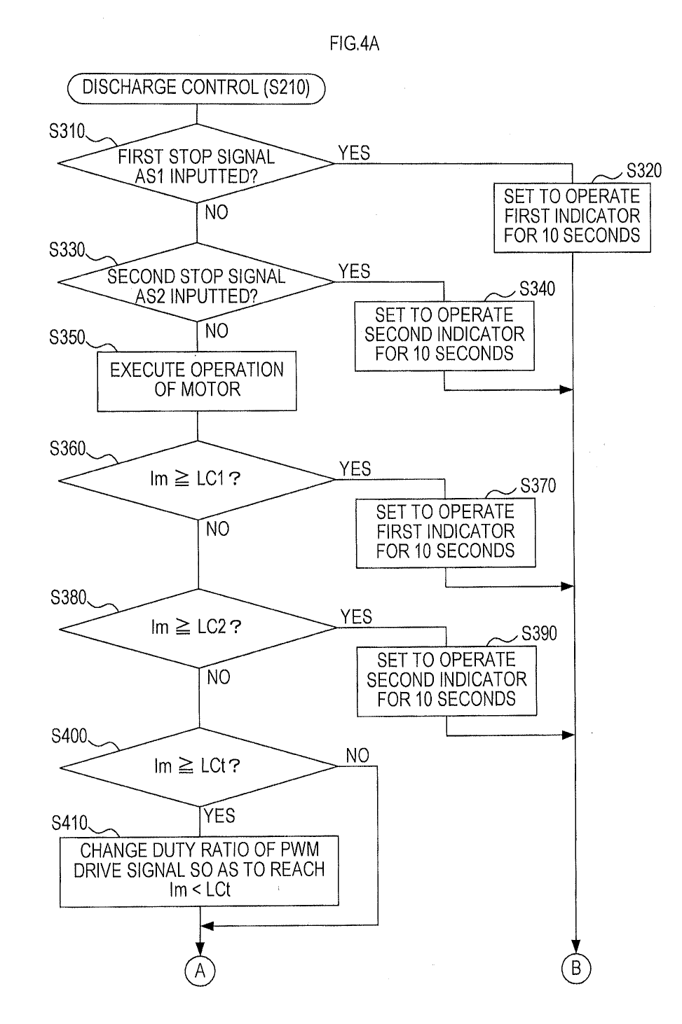

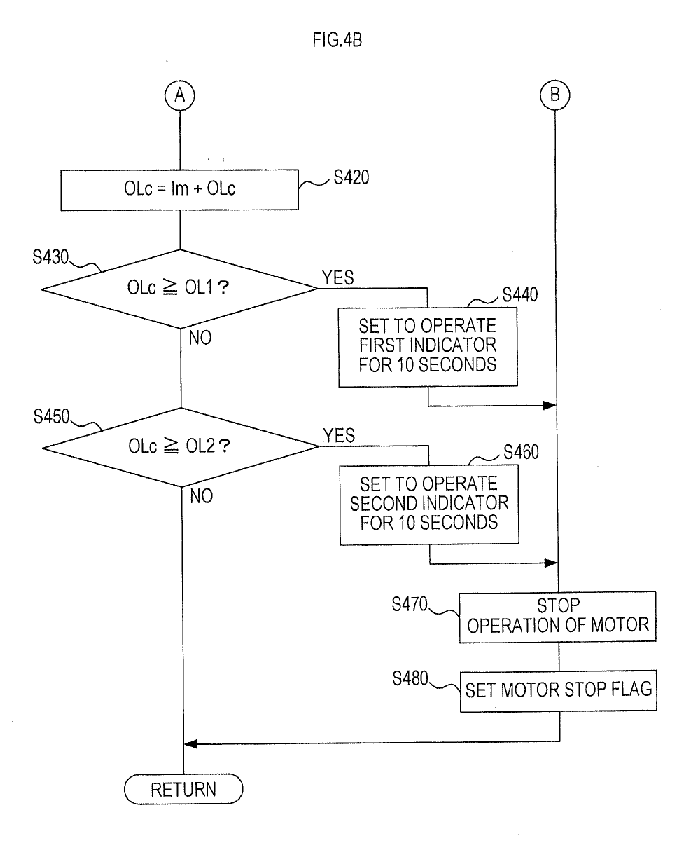

The details of the discharge control process in S210 are as shown in FIG. 4A and FIG. 4B. When starting the discharge control process shown in FIG. 4A and FIG. 4B, the MCU 62 determines in S310 whether the first stop signal AS1 is inputted from the first battery pack 11. If the first stop signal AS1 is not inputted, the process proceeds to S330. If the first stop signal AS1 is inputted, a setting is made in S320 to operate the first indicator 16 (i.e., to light an LED) for 10 seconds. The time period of 10 seconds for operating the indicator is only an example. The same is applicable to later-described individual processes in S340, S370, S390, S440, and S460.

Once the setting is made in S320 to operate the first indicator 16 for 10 seconds, the first indicator 16 is operated for 10 seconds. Specifically, the LED provided to the first indicator 16 is lit for 10 seconds. After the setting to operate the first indicator 16 in S320, the process by the MCU 62 proceeds to S470 (see FIG. 4B). In S470, operation of the motor 61 is stopped. That is, output of the PWM drive signal Dp is stopped (i.e., the duty ratio is set to “0”). Then, a motor stop flag is set in S480, and the present discharge control process is terminated.

In a case where the operation of the motor 61 is stopped in S470 after the setting to operate the first indicator 16 in S320, a user can recognize that the motor 61 is stopped due to the first battery pack 11 by the fact that the first indicator 16 is operating. The same is applicable to a case where the operation of the motor 61 is stopped in S470 through a later-described S370 or S440.

In S330, it is determined whether the second stop signal AS2 is inputted from the second battery pack 12. If the second stop signal AS2 is not inputted, the process proceeds to S350. If the second stop signal AS2 is inputted, a setting is made in S340 to operate the second indicator 17 for 10 seconds.

Once the setting is made in S340 to operate the second indicator 17 for 10 seconds, the second indicator 17 is operated for 10 seconds. The process by the MCU 62 after the setting to operate the second indicator 17 in S340 is to stop the operation of the motor 61 in S470, to set a motor stop flag in S480, and to terminate the present discharge control process.

In a case where the operation of the motor 61 is stopped in S470 after the setting to operate the second indicator 17 in S340, a user can recognize that the motor 61 is stopped due to the second battery pack 12 by the fact that the second indicator 17 is operating. The same is applicable in a case where the operation of the motor 61 is stopped in $470 through a later-described S390 or S460.

If any of the stop signals AS1 and AS2 is not inputted (S330: NO), motor operation is executed in S350. That is, a PWM drive signal Dp having a duty ratio according to the amount of pulling operation of the trigger switch 9 is outputted to thereby operate (rotate) the motor 61.

In S360, it is determined whether the drive current Im flowing in the motor 61 is equal to or greater than the overcurrent threshold LC1 of the first battery pack 11. If the drive current Im is smaller than the overcurrent threshold LC1, the process proceeds to S380. If the drive current Im is equal to or greater than the overcurrent threshold LC1, a setting is made in S370 to operate the first indicator 16 for 10 seconds in the same manner as in S320, and then the process proceeds to S470 and the subsequent step. That is, the operation of the motor 61 is stopped.

In S380, it is determined whether the drive current Im flowing in the motor 61 is equal to or greater than the overcurrent threshold LC2 of the second battery pack 12. If the drive current Im is smaller than the overcurrent threshold LC2, the process proceeds to S400. If the drive current Im is equal to or greater than the overcurrent threshold LC2, a setting is made in S390 to operate the second indicator 17 for 10 seconds in the same manner as in S340, and then the process proceeds to S470 and the subsequent step. That is, the operation of the motor 61 is stopped.

If the drive current Im is smaller than any of the overcurrent thresholds LC1 and LC2 (S380: NO), it is determined in S400 whether the drive current Im is equal to or greater than the limited current LCt. If the drive current Im is smaller than the limited current LCt, the process proceeds to S420 (see FIG. 4B). If the drive current Im is equal to or greater than the limited current LCt, the duty ratio of the PWM drive signal is changed in S410 such that the drive current Im becomes less than the limited current LCt, and the process proceeds to S420.

There may be various processes of specifically changing the duty ratio of the PWM drive signal Dp in S410. For example, a conceivable process is to gradually reduce the duty ratio until the drive current Im becomes equal to or less than the limited current LCt. Specifically, in this process, the duty ratio is reduced by a small specified amount and the determination in S400 in the next control cycle is waited; if the drive current Im is still equal to or greater than the limited current LCt, the duty ratio is reduced again by the specified amount in S410. An alternative process is, for example, to calculate, on the basis of a difference between the drive current Im and the limited current LCt, a reduction amount of the duty ratio so as to make the difference zero, and to reduce the duty ratio by the reduction amount.

In S420, an integration process of the load counter is performed. Specifically, the load counter value OLc is updated by adding a value of the drive current Im (a resulting value of AD conversion in the MCU 62) to the current load counter value OLc. When the trigger switch 9 is turned off, the load counter value OLc is cleared by the process in S200 shown in FIG. 3. Accordingly, the load counter value OLc indicates a time-integrated value of the drive current (discharge current) Im of the motor 61 while the trigger switch 9 is ON (during a time period while the discharge to the motor 61 is continued).

After integration of the load counter value OLc is performed in S420, it is determined in S430 whether the load counter value OLc is equal to or greater than the overload threshold OL1 of the first battery pack 11. If the load counter value OLc is smaller than the overload threshold OL1, the process proceeds to S450. If the load counter value OLc is equal to or greater than the threshold OL1, a setting is made in S440 to operate the first indicator 16 for 10 seconds in the same manner as in S320, and then the process proceeds to S470 and the subsequent steps. That is, the operation of the motor 61 is stopped.

In S450, it is determined whether the load counter value OLc is equal to or greater than the overload threshold OL2 of the second battery pack 12. If the load counter value OLc is smaller than the overload threshold OL2, the present discharge control process is terminated. If the load counter value OLc is equal to or greater than the overload threshold OL2, a setting is made in S460 to operate the second indicator 17 for 10 seconds in the same manner as in S340, and then the process proceeds to S470 and the subsequent steps. That is, the operation of the motor 61 is stopped.

In the processes in S320 and S340 to operate corresponding indicators by the respective stop signals AS1 and AS2 from the respective battery packs 11 and 12, different manners of operation from those in S370, S390, S440, and S460 may be employed, in order for a user to recognize that a protective function of the battery pack is activated. This enables the user not only to know, when the motor 61 stops, which battery pack is the cause of the stop on the basis of the state of operation of the indicators, but also to recognize whether activation of the protective function of the battery pack has caused the stop or the monitoring function of the main body has caused the stop.

(4) Effects and the Like of Embodiment

According to the motor-driven appliance 1 of the present embodiment as described above, various control parameters, including the thresholds LC1, LC2, OL1, and OL2, and the limited current LCt, for the discharge control are set at least in light of the discharge capacity of the battery having the lowest discharge capacity in the attached battery packs 11 and 12. This enables achievement of the discharge control on the basis of appropriate control parameters at least in light of the battery having the lowest discharge capacity. Accordingly, even when the batteries 20 and 40 have different discharge capacities, it is possible to reduce damage to the batteries (particularly to the battery having a lower discharge capacity) due to the discharge, to thereby perform appropriate discharge control.

In the motor-driven appliance 1 of the present embodiment, control parameters to limit or stop discharge, and more specifically overcurrent thresholds, overload thresholds, and a limited current are set as control parameters on the basis of at least the discharge capacity of the battery having the lowest discharge capacity. Accordingly, it is possible to effectively protect the batteries 20 and 40 from overcurrent and overload, and also to control the discharge current during a normal operation within a limited current range. Thus, it is possible to further effectively reduce damage to the battery having the lowest discharge capacity.

As discharge capacity information to acquire from the battery packs 11 and 12, in the present embodiment, respective internal resistance values DCIR1 and DCIR2 indicating the respective degrees of degradation of the batteries 20 and 40 are acquired, and control parameters are set on the basis of the values. Accordingly, it is possible to effectively reduce damage to the batteries 20 and 40 (particularly to the battery having the highest degree of degradation) due to the discharge, to thereby perform appropriate discharge control.

Moreover, it is configured to acquire from the battery packs 11 and 12, as discharge capacity information, the thresholds LC1, LC2, OL1, and OL2 that indicate initial characteristics of the battery cells forming the batteries. Also, the control parameters are set using such information. Accordingly, it is possible to effectively reduce damage to the batteries 20 and 40 (particularly to the battery having the lowest discharge capacity indicated by the initial characteristics) due to the discharge, to thereby perform appropriate discharge control.

In the present embodiment, any of the internal resistance values DCIR1 and DCIR2, the overcurrent thresholds LC1 and LC2, and the overload thresholds OL1 and OL2 correspond to examples of the discharge capacity information of the present invention. Also, in the present embodiment, the MCU 62 of the main body directly uses the overcurrent thresholds LC1 and LC2, and the overload thresholds OL1 and OL2 for discharge control. Accordingly, the overcurrent thresholds LC1 and LC2, and the overload thresholds OL1 and OL2 in the present embodiment are examples of the discharge capacity information of the present invention as well as examples of the control parameters of the present invention. The limited current LCt is also an example of the control parameters of the present invention. Also, in the present embodiment, each of the drive current Im and the load counter value OLc corresponds to an example of a physical quantity indicating the state of discharge in the present invention.

### OTHER EMBODIMENTS

(1) In the above-described embodiment, the internal resistance value DCIR, the overcurrent threshold LC, and the overload threshold OL are acquired as information indicating the discharge capacity of each of the batteries 20 and 40, and control parameters are set on the basis of the information to perform discharge control. However, the information indicating the discharge capacity of each of the batteries 20 and 40 is not limited to these values.

For example, in a case where an overdischarge threshold indicating a lowest voltage during the discharge of each of the batteries 20 and 40 can be acquired from each of the battery pack 11 and 12, it may be possible to acquire the overdischarge thresholds, and to set an overdischarge threshold for the entire motor-driven appliance on the basis of the overdischarge threshold of the battery having the highest overdischarge threshold (that is, the battery having the lowest discharge capacity) to perform discharge control. In other words, the discharge may be stopped when the voltage applied to the motor 61 (the voltage between the first positive terminal 81 and the second negative terminal 92) becomes less than the overdischarge threshold.

(2) In the above-described embodiment, determination of overcurrent and determination of overload are performed directly using the overcurrent thresholds LC1 and LC2, and the overload thresholds OL1 and OL2 acquired from the batteries 20 and 40 as control parameters. However, this is merely an example. It may be possible to set a separate threshold using the overcurrent thresholds LC1 and LC2, and the overload thresholds OL1 and OL2 acquired from the batteries 20 and 40, and to perform discharge control using the separately set threshold.

(3) In the above-described embodiment, discharge control is performed on the basis of the discharge capacities of both of the batteries 20 and 40. However, it may be possible to set control parameters only on the basis of the discharge capacity of the battery having the lowest discharge capacity, and to perform discharge control. Specifically, for example, if the internal resistance value DCIR1 of the first battery pack 11 is greater than the internal resistance value DCIR2 of the second battery pack 12, control parameters, such as the limited current LCt, may be set using the internal resistance value DCIR1 of the first battery pack 11 without using the internal resistance value DCIR2 of the second battery pack 12. Also, for example, if the overcurrent threshold LC1 of the first battery pack 11 is greater than the overcurrent threshold LC2 of the second battery pack 12, control parameters may be set using the overcurrent threshold LC2 of the second battery pack 12 without using the overcurrent threshold LC1 of the first battery pack 11.

(4) In the above-described embodiment, the internal resistance value DCIR of a battery is exemplified particularly as information indicating the degree of degradation of the battery among information indicating the discharge capacity of the battery. However, this is only for an example. Although the overcurrent threshold and the overdiseharge threshold are exemplified particularly as information indicating the initial characteristics of the battery cell among information indicating the discharge capacity of the battery, these are also only for examples.

(5) Although the motor-driven appliance 1 to be used with the two battery packs 11 and 12 attached thereto is described in the above-described embodiment, the present invention may be applied to other types of motor-driven appliances to be used with three or more battery packs attached thereto and serially connected together. In the case of the configuration with three or more battery packs attached thereto, it may be possible to set control parameters on the basis of the discharge capacity of at least the battery pack having the lowest discharge capacity among the three battery packs, and to perform discharge control.

The high or low of the discharge capacity may vary depending on each type of information indicating the discharge capacity. For example, there may be a case where the first battery pack 11 has a greater internal resistance value DCIR than the second battery pack 12, whereas the second battery pack 12 has a greater overcurrent threshold LC than the first battery pack 11. In such case, the second battery pack 12 may be considered to have a lower discharge capacity in terms of the internal resistance value DCIR; however, the first battery pack 11 may be considered to have a lower discharge capacity in terms of the overcurrent threshold LC.

(6) Although an indicator is provided to each of the battery packs in the above-described embodiment, this is not necessarily required. Notification using an LED is not necessarily required, either. As long as a user can recognize which battery has caused the motor 61 to stop operation, there is no limitation to a specific manner of notification.

(7) Although it is described in the above-described embodiment that the MCU 62 in the main body comprises a microcomputer, the MCU 62 is not limited to a microcomputer, but may comprise, for example, an ASIC, an FPGA, an IC of any of various types, a logic circuit, etc.

(8) Although the motor 61 is a brushed DC motor in the above-described embodiment, the present invention may also be applied to a motor-driven appliance with a motor other than a brushed DC motor (such as a brushless motor or an AC motor of any of various types).

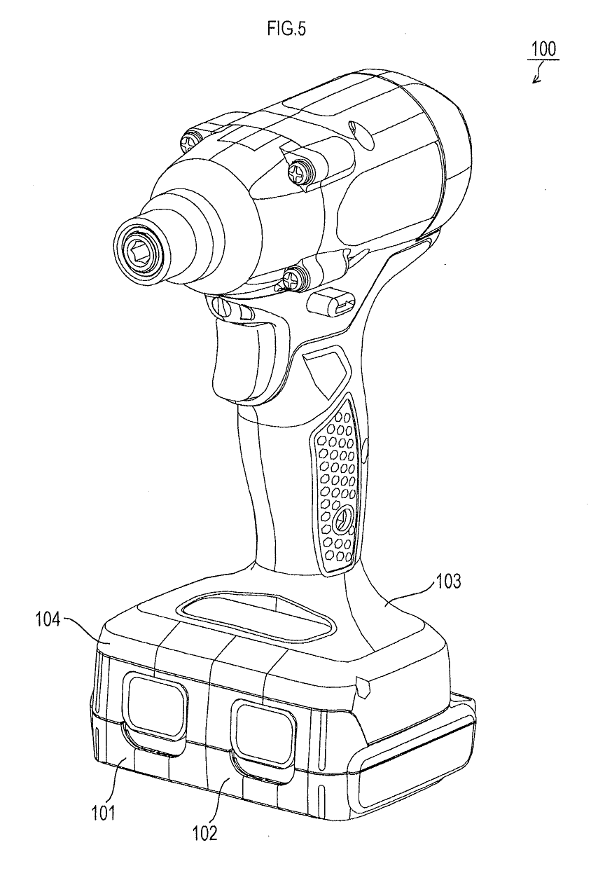

(9) Although the above-described embodiment shows an example in which the present invention is applied to an electric working machine (specifically a brush cutter), the present invention may be applied not only to an electric working machine but also to any types of motor-driven appliances. For example, the present invention may be applied to the motor-driven appliance 100 exemplified in FIG. 5. The motor-driven appliance 100 shown in FIG. 5 is configured specifically as an electric power tool for use in boring a hole in or tightening a screw into a target material.

The motor-driven appliance 100 shown in FIG. 5 is used with two battery packs 101 and 102 attached to a battery attachment unit 104 of a main body 103. When the two battery packs 101 and 102 are attached to the battery attachment unit 104, the batteries in the battery packs 101 and 102 are serially connected together to thereby provide a power source for a motor housed in the main body 103. The present invention may be applied to the motor-driven appliance 100 configured as above, and the motor drive control, the discharge control, or the like may be performed in the main process shown in FIG. 3.

1. A motor-driven appliance comprising:
a plurality of battery packs, each comprising a battery contained therein:
an attachment unit to which the plurality of battery packs are detachably attached;
a power source forming unit configured to form a power source by serially connecting the respective batteries of the plurality of battery packs when the plurality of battery packs are attached to the attachment unit;
a motor configured to operate by electric power from the power source;
an information acquisition unit configured to acquire, from each of the plurality of battery packs, discharge capacity information that is information indicating a discharge capacity of the contained battery;
a control parameter setting unit configured to set at least one control parameter to control discharge from the power source to the motor in accordance with at least the discharge capacity information of a battery having a lowest discharge capacity, on the basis of the respective discharge capacity information acquired by the information acquisition unit; and
a control unit configured to control the discharge from the power source to the motor by using the at least one control parameter set by the control parameter setting unit.

2. The motor-driven appliance according to claim 1,
wherein at least one of the at least one control parameter indicates a limitation range to limit or stop the discharge with respect to a physical quantity indicating a state of discharge from the power source, and
wherein the control unit limits or stops the discharge from the power source to the motor when the physical quantity enters the limitation range indicated by the corresponding control parameter.

3. The motor-driven appliance according to claim 2,
wherein the control parameter setting unit sets, as the control parameter, at least one of an overcurrent threshold that is an upper limit of a discharge current during the discharge from the power source to the motor, an overdischarge threshold that is a lower limit of a voltage of the power source during the discharge, and an overload threshold that is an upper limit of an integrated value of the discharge current from the power source while the discharge to the motor is continuously performed.

4. The motor-driven appliance according to claim 1,
wherein the discharge capacity information comprises at least information indicating a degree of degradation of each of the batteries, and
wherein the control parameter setting unit sets the at least one control parameter on the basis of the degree of degradation of a battery with a highest degree of degradation.

5. The motor-driven appliance according to claim 1,
wherein the discharge capacity information comprises at least information indicating initial characteristics of battery cells forming each of the batteries, and
wherein the control parameter setting unit sets the at least one control parameter on the basis of the initial characteristics of a battery with a lowest discharge capacity indicated by the initial characteristics.

6. The motor-driven appliance according to claim 1,
wherein the control parameter setting unit sets, as the control parameter, at least one of an overcurrent threshold that is an upper limit of a discharge current during the discharge from the power source to the motor, and an overload threshold that is an upper limit of an integrated value of the discharge current from the power source while the discharge to the motor is continuously performed, and
wherein the motor-driven appliance further comprises a notification unit configured to give a specified notification indicating a battery having a lowest discharge capacity when, among the physical quantities indicating the state of discharge from the power source, a physical quantity corresponding to the overcurrent threshold or the overload threshold has reached the corresponding threshold.

7. A main body of a motor-driven appliance comprising:
an attachment unit to which a plurality of battery packs are detachably attached;
a power source forming unit configured to form a power source by serially connecting the respective batteries of the plurality of battery packs when the plurality of battery packs are attached to the attachment unit;
a motor configured to operate by electric power from the power source;
an information acquisition unit configured to acquire, from each of the plurality of battery packs, discharge capacity information that is information indicating a discharge capacity of a battery contained therein;
a control parameter setting unit configured to set at least one control parameter to control discharge from the power source to the motor in accordance with at least the discharge capacity information of a battery having a lowest discharge capacity, on the basis of the respective discharge capacity information acquired by the information acquisition unit; and
a control unit configured to control the discharge from the power source to the motor by using the at least one control parameter set by the control parameter setting unit.
